(19) United States
(12) Patent Application Publication
(10) Pub. No.: US 2005/0110868 A1
(43) Pub. Date: May 26, 2005

(54) System and method for inputting contours of a three-dimensional subject to a computer

(76) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314, US

(21) Appl. No.: 09/969,583

(22) Filed: Oct. 4, 2001

(51) Int. Cl. H04N 13/02; H04N 15/00

(52) U.S. Cl. 348/47

(57) ABSTRACT

At least one two-dimensional infrared grid is projected onto a three-dimensional subject in order to determine or represent contours of the subject based on distortion of the grid. The grid is separated from a composite visible-infrared image by a beam splitter. If two grids are superposed for a stereoscopic effect, the two grids preferably have different infrared wavelengths and are separable by a second beam splitter.

### BACKGROUND OF THE INVENTION

1. Field of the Invention

This invention relates to a system and method for enabling input, to a computer or other electronic processing device, of data concerning the three-dimensional contours or profiles of an inanimate or animate subject.

The invention involves projecting one or more infrared grids or similar patterns onto the subject, the projected infrared grid(s) or pattern(s) reflecting contours of the subject. The subject may be illuminated by any type of illumination, including visible light, so long as the resulting image of the subject can be distinguished from the image or images of the infrared grid or grids (or other patterns, hereinafter referred-to simply as “grids”).

Preferably, the image or images of the infrared grid or grids are optically separated from the image of the subject by using a beam splitter that transmits or reflects the respective images of the grid or grids and subject to different detectors that capture the separated images for display or analysis.

More specifically, the invention has the following aspects:
a. Projection of a two-dimensional grid onto a three-dimensional subject in order to determine contours of the subject based on distortion of the grid;
b. Projection of multiple two-dimensional grids onto the subject in order enable stereoscopic rendering of the subject without the need for stereoscopic camera arrangements or scanning;
c. Use of infrared light to form the grid(s) so as to easily distinguish the grids from a composite image of the subject and grid(s);
d. Use of grids having different infrared frequencies so that multiple grids may more easily be distinguished from each other;
e. Optical separation of a grid or grids from the composite image so as to simplify electronic processing;
f. Optical separation of multiple grids from each other so as to simplify subsequent electronic processing;
g. Use of a beam splitter to extract the grids from the visible light portion of the composite image of the subject;
h. Use of a beam splitter to distinguish the two infrared grids.

The separated images of the subject and the lines of the grid may be input to a computer or other image processing or display device for any of a variety of purposes, including generation of a three-dimensional representation of the subject, detection or analysis of subject movements, detection of flaws in the subject, subject identification or recognition, targeting or range finding by using movable grids, and so forth.

Among the numerous advantages of the invention are simplification of hardware by, for example, eliminating the need for scanning, and simplification of software by eliminating the need for feature analysis or pattern matching in order to distinguish the grid lines or contours.

2. Description of Related Art

The ability to rapidly capture or render three-dimensional images of a subject so as to track movements of the subject, and/or to draw the subject as it moves, has been a goal of computer programmers for many years. One of the initial applications for three-dimensional image capture and processing was to detect defects in the surfaces of manufactured items. More recently, proposals have been made to use three-dimensional image input systems and methods to control computers based on hand or eye movements, to insert images of persons into video games, to track movements of the subject to analyze the movements or so that the subject can interact with the video game or other virtual reality program, and/or to identify or recognize persons based on their profiles.

All of these applications require substantial processor resources, and even the simplest such systems tend to stretch the limits of currently available computer systems. The technology for utilizing three-dimensional data input is developing rapidly, but commercialization of the technology has been limited by either (i) the cost and complexity of current data input hardware and control software, or (ii) if simpler input means are used, the cost and complexity of image processing software necessary to make sense of the data. The present invention seeks to simplify both image capture hardware and the image processing software necessary to enable a projected grid to be captured, displayed, and/or analyzed.

To accomplish this, the present invention enables input of a reference grid that captures the contours of the subject, and yet that can be separated from the image of the subject by using a grid formed by light having a frequency different than that used to illuminate the subject on which the grid is superimposed, and by using simple optical means such as beam splitters to capture an electronic image of the grid that can be processed without the need to electronically separate it from its background. The contours represented by the optically separated grid can then be displayed without further electronic processing, or analyzed using relatively simple numerical analysis rather than more difficult qualitative analysis. While systems and methods that utilize grid projection are known, none simplifies processing as much as the present invention.

The following references illustrate general principles of three-dimensional imaging, but fail to show either the grid projection or image separation aspects of the present invention:

With respect to the grid projection aspect of the invention, U.S. Pat. No. 6,252,623 discloses imposing a three-color grid pattern on a subject, but the grid is created by projecting visible rather than infrared light through a color grating, and separating the colors of the one-dimensional grid electronically rather than optically based on pixels activated by the CCD. As a result, this system shares with other prior systems Because the grid is formed by visible light, this system shares with other prior systems the problem of separating the grid from background.

U.S. Pat. No. 6,205,243 discloses a system that projects laser scan lines onto a subject with sufficient rapidity to form a “mesh” in the composite image that can be used to determine surface contours. However, the use of laser scanning in the system of this patent makes the system much more complicated than is the case with a system that uses multiple light frequencies.

U.S. Pat. No. 5,982,352 discloses use of grid distortion to indicate the location and force of contact between a user and a surface, such as a touch screen surface or the floor. In several examples, the grid is projected onto the surface and captured by a “tv camera” connected to a computer, but the grid is a single frequency grid.

Finally, with respect to the grid projection aspect of the invention, U.S. Pat. No. 6,191,850 discloses projection of a grid pattern onto an object of manufacture for the purpose of detecting surface defects, but the grid pattern again utilizes light having only a single frequency.

With respect to the optical separation or beam splitter aspect of the invention, U.S. Pat. No. 5,910,816 discloses the use of dichroic beam splitters to separate visible and infrared components of an image, but the infrared components are not further separated by frequency, and do not represent a grid.

In addition, by way of background, numerous references disclose generation of a three-dimensional representation of a subject by utilizing scanning and/or complex image processing that does not rely on reference grids. For example, FIG. 3 of U.S. Pat. No. 5,531,520 shows “striping” created by processing data generated by a laser scanner. The striping is overlaid over an image of a or tumor for the purpose of assisting a surgeon in locating the tumor.

Similar laser scanning systems, for analyzing objects in a manufacturing setting, are disclosed in U.S. Pat. Nos. 4,628,469 and 4,498,778.

U.S. Pat. No. 5,129,010 discloses use of “infrared laser slit light” for the purpose of determining the flushness of an automobile assembly, but the “slit light” is scanned and does not form a grid, while U.S. Pat. Nos. 5,280,542 and 4,600,012 disclose similar systems utilizing non-infrared pulsed slit lines.

U.S. Pat. No. 4,914,460 discloses projection of a laser grid in the form of linear series of discrete spots onto an object, but only for the purpose of determining position and orientation of a submarine object.

U.S. Pat. Nos. 6,009,210 and 6,215,471 disclose a purely electronic computer input device which tracks a face by comparing an image of the face with reference images representing different positions, while U.S. Pat. No. 6,215,471 tracks a face by tracking movement of “landmarks” on the face, and U.S. Pat. No. 5,767,842 discloses a similar system for fingers.

U.S. Pat. No. 4,499,492 is representative of a number of patents disclosing “range imaging employing parallax” which utilizes scanning to determine the distance to a selected point on an object. U.S. Pat. No. 6,198,485 discloses using such a range finding system to track a marker placed on a finger.

The concept of using three-dimensional object sensing as a computer input means is also disclosed in U.S. Pat. No. 5,900,863, but the object sensing is either based on parallax range finding, or on determining object parameters by determining which of an array of light beams is reflected (or blocked) by the object. A more sophisticated and complex version of a computer input that employs object detection by pixel-analysis input device is disclosed in U.S. Pat. No. 6,144,366.

U.S. Pat. Nos. 6,002,808 and 6,222,465 disclose a respective “hand gesture control” and “video gesture recognition” system in which images of a hand are electronically analyzed to detect movement.

U.S. Pat. No. 5,235,416 discloses use of two cameras sensitive to different wavelengths, and two corresponding illumination sources to simultaneously image two sides of an object without interference, but does not disclose any sort of grid.

Finally, U.S. Pat. No. 5,528,263 discloses a system in which a grid is projected onto a two-dimensional projection screen to enable location of a pointer, rather than being projected onto a three-dimensional surface to indicate contours of the surface.

### SUMMARY OF THE INVENTION

It is according a first objective of the invention to provide a simple and inexpensive system and method for inputting contours of a subject to a computer or other electronic processing device.

It is a second objective of the invention to provide a system and method for establishing contours of the subject in a way that eliminates the need for feature extraction, interpolation, and other complex image processing software or algorithms.

It is a third objective of the invention to provide a system and method for inputting contours of a subject to a computer or other electronic processing device, and which does not require complex scanning hardware or software but rather may use ordinary fixed cameras and conventional light sources.

It is a fourth objective of the invention to provide a system and method for capturing contours of a three-dimensional subject that permits the contours to be captured and displayed without any further electronic processing.

It is a fifth objective of the invention to provide a system and method for capturing contours of a three-dimensional subject that enables correlation of superposed grid lines and a visible light image of the subject, while permitting direct analysis of the grid lines without the need for electronically separating the grid lines from the visible light image of the subject.

These objectives are accomplished, in accordance with the principles of a preferred embodiment of the invention, by providing a system and method for capturing contours of a three-dimensional subject in which a two-dimensional grid is projected onto the three-dimensional subject in order to determine contours of the subject based on distortion of the grid.

The objectives of the invention are further accomplished by providing a system and method for capturing contours of a three-dimensional subject in which multiple two-dimensional grids are projected onto the subject in order to enable stereoscopic rendering or display of the subject without the need for stereoscopic camera arrangements or scanning.

The objectives of the invention are still further accomplished by providing a system and method for capturing contours of a three-dimensional subject which uses infrared light to form at least one grid so as to easily distinguish the at least one grid from a composite image of the subject and grid, and which in the case where multiple grids are used to achieve a stereoscopic effect without the need for multiple cameras, uses different infrared frequencies so that the multiple grids may more easily be distinguished from each other.

The objectives of the invention are also accomplished by providing a system and method for capturing contours of a three-dimensional subject which uses optical separation of a grid from the composite image so as to simplify electronic processing, and which in the case where multiple grids are used to achieve a stereoscopic effect without the need for multiple cameras situated at different angles, uses optical separation of the multiple grids from each other so as to further simplify subsequent electronic processing.

Finally, the objectives of the invention are accomplished by providing a system and method for capturing contours of a three-dimensional subject which uses a beam splitter to extract the grids from the visible light portion of the composite image of the subject, and a beam splitter to distinguish the two infrared grids.

Those skilled in the art will appreciate that any of the above-described aspects or embodiments of the invention may be used in connection with any of the applications three-dimensional imaging noted above, including generation of a three-dimensional representation of a subject, detection or analysis of subject movements, detection of flaws in the subject, subject identification or recognition, and targeting or range finding, as well as in applications not specifically mentioned herein.

To this end, the invention is not to be limited to capture of grids by a particular camera or detector arrangement or type, or to particular numbers, arrangements, or types of projection equipment. Either the grid projectors or the detectors may be fixed or movable, each grid may be captured by one or more detectors, and each detector may be arranged to capture one or more grids. Furthermore, in certain circumstances, the “grids” may be in the form of patterns other than grids made up of mutually perpendicular sets of lines, or may be collapsed into one-dimensional lines captured by separate detectors and combined following detection. In addition, the grids may be projected in combination with other types of indicia such as hash marks used for targeting or range finding.

### BRIEF DESCRIPTION OF THE DRAWINGS

FIG. 1 is a side view of a subject illuminated by a single infrared grid projection system constructed in accordance with the principles of a preferred embodiment of the invention.

FIG. 2 is a side view illustrating the use of multiple projection systems to complete a 360° view of the subject.

FIG. 3 is a front view of the subject illustrated in FIG. 1.

FIG. 4 is a perspective view showing grid distortion along contours of the subject illustrated in FIG. 1.

FIG. 5 illustrates a captured image taken in the presence of visible light and containing two infrared grids projected from different angles, together with the results of wavelength separation of the composite image into separate images of the two infrared grids and a visible image of the subject.

FIGS. 6 and 7 illustrated filtering apparatus utilized by the preferred embodiment of the invention.

FIG. 8 is a schematic illustration showing use of the invention for range finding.

### DETAILED DESCRIPTION OF THE PREFERRED EMBODIMENTS

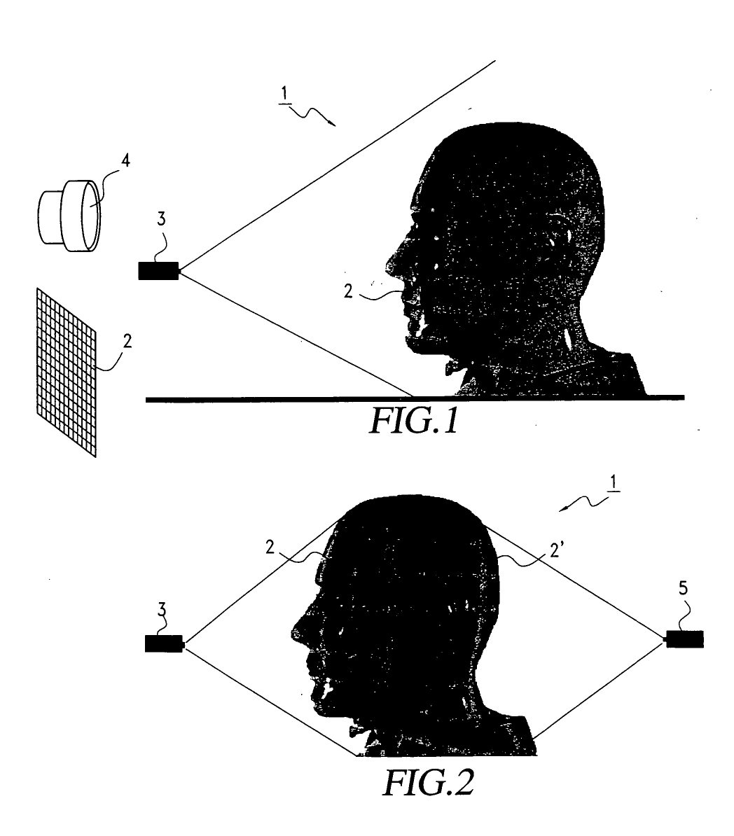

FIG. 1 illustrates an embodiment of the invention in which the subject 1 is illuminated by a single infrared grid 2 projected from the front of the subject by a projector 3. The subject 1 may also be illuminated by a substantially uniform light source 4, by multiple light sources, or by ambient light.

In a variation of the embodiment of FIG. 1, multiple grids 2 and 2′ may be projected onto the subject in order to enable capture of contours for the entire 360° of the subject by using an additional camera 5 (or, equivalently, by moving projector 3 around the subject), as illustrated in FIG. 2.

Each grid shown in FIGS. 1 and 2 is preferably an infrared grid having a wavelength of sufficient intensity to enable an image of the grid to be captured despite background infrared radiation that might be emitted by the subject, and is made up of mutually perpendicular horizontal and vertical lines. Suitable infrared light sources are well-known, as are cameras and film capable of capturing infrared light. The projectors 3 and 5 may be simple lamp and mask arrangements in which the lamp is arranged to illuminate the subject through a mask having openings in the shape of a grid, or an arrangement in which the lamp is reflected by a grid-shaped reflector, although the invention is not to be limited to such lamp and mask or reflector arrangements.

Light source 4 may be a visible, infrared, or ultraviolet light source for enabling the camera to capture features of the subject other than the contours reflected in the captured grid. According to the principles of the invention, the exact wavelength or wavelengths of light source 4 may be freely varied to meet requirements of the application in which the invention is used, except that the wavelength or wavelengths emitted by the light source 4 must be different than those emitted by projector 3. As explained below, use of different wavelengths to illuminate the subject as a whole than are used for the grid makes it possible to more easily separate the image of the grid from that of the subject.

It may, in some circumstances, be useful simply to capture an image of the infrared grid without illumination of the entire subject, in which case lamp 4 may be omitted. On the other hand, a significant advantage of the invention is that it permits a visible, ultraviolet, or infrared light image of the subject to be captured with the grid superposed so that aspects of the subject such as coloring, and also details of physical features smaller than the smallest grid unit, can be captured and located with reference to the grid.

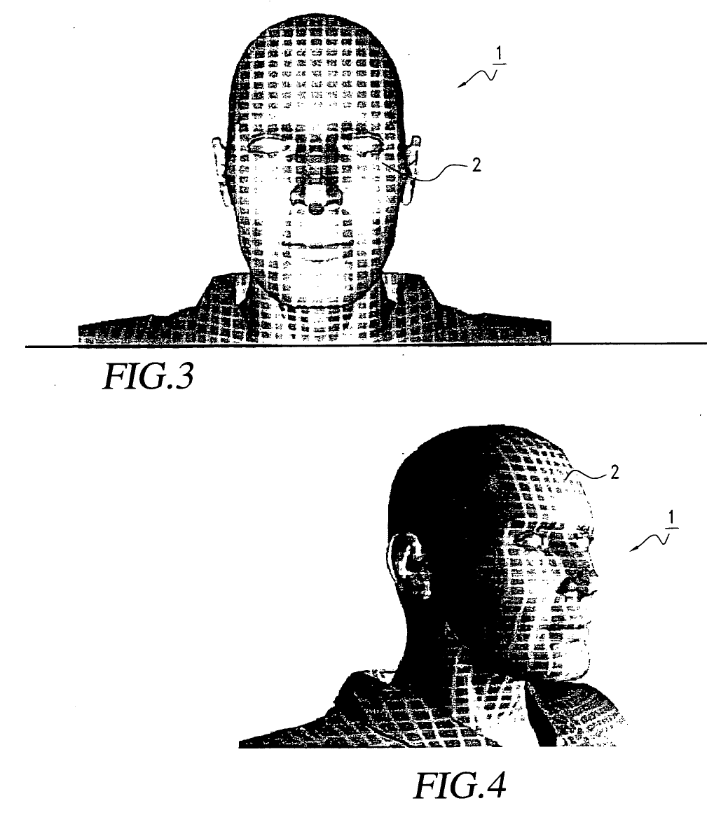

As illustrated in FIG. 3, the use of a single grid 2, or corresponding single grids 2 and 3 projected onto the front and back of the subject, does not by itself permit contours of the subject to be determined. Instead, contours of the subject are only revealed by capturing the image at an angle relative to the subject, as illustrated in FIG. 4. By using two cameras on each side of the projector, a stereoscopic view can be captured using a single grid.

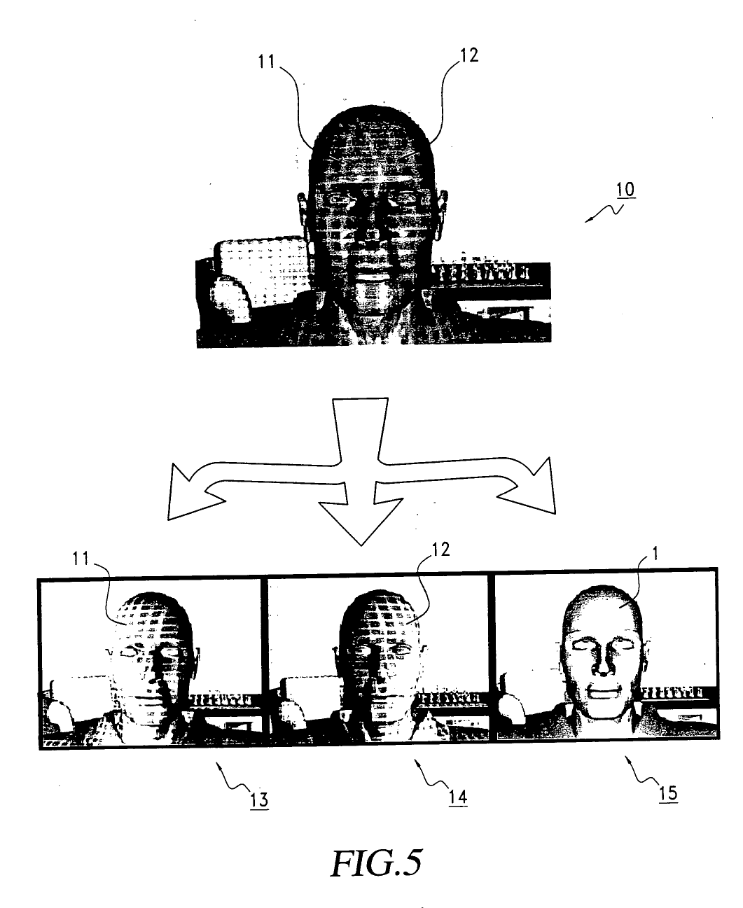

In order to avoid the need to capture two images of the subject, however, it is also possible to create a stereoscopic effect by orienting the projectors at angles relative to the subject, and positioning the camera midway between the projectors, as illustrated in FIG. 5. Image 10 in FIG. 5 is a front view of the subject onto which has been projected two infrared grids 11 and 12 using two projectors (not shown) of the type illustrated in FIG. 2, oriented at equal angles on each side of the camera or image capture apparatus. According to the principles of the invention, the composite image 10 consists of, and may be separated into, three constituent images: (i) an image 13 of the first grid 11, (ii) an image 14 of the second grid 12, (iii) a image 15 of the subject without the grids. Although images 13 and 14 show the subject and background, the subject and background can be made to disappear by selecting appropriate grid wavelengths and bandwidths of the filters or beam splitters used to separate the images, leaving only images of the respective grids. Of course, by adding one or more cameras and projectors to the arrangement illustrated in FIG. 5, or by moving the cameras and projectors of FIG. 5 around the subject, it is possible to capture a 360° view of the subject.

Separation of image 15 from images 13 and 14 is accomplished, as described above, by using different wavelengths for image 15 and the grids in images 13 and 14. In addition, the left and right grids in images 13 and 14 are preferably also projected using light sources of different frequency.

Image processing techniques for generating a three-dimensional image of a subject based on contours are well-known and need not be described in detail herein. However, image processing is uniquely facilitated in the system and method of the present invention by including a filtering device 20 that optically, rather than electronically, separates the one or more infrared grids from the visible light image. This device may be used to separate light reflected directly from the subject, in lieu of a camera, or may be used to process a recorded image or slide, or an image of the subject displayed on a CRT, LCD, or the like.

The filter device 20 includes a pair of beam splitters 21 and 22, one of which is arranged to separate the infrared light of the grid from the light used to illuminate the subject, which may be visible light, and the other of which is arranged to separate infrared light of different frequencies. The first beam splitter transmits the image of the subject to a detector A while reflecting the infrared light images of the two grids. The second beam splitter separates the infrared light images of the two grids into separate images of the respective grids by transmitting one frequency of infrared light to a detector B and the other frequency of infrared light to a detector C for separate, simplified processing.

In the variation illustrated in FIG. 7, device 25 includes beam splitters 26 and 27 arranged to separate light of different frequencies in the same manner as beam splitters 21 and 22, except that the image of the subject is reflected rather than transmitted to detector A, and the image of the first grid is reflected rather than transmitted to detector B.

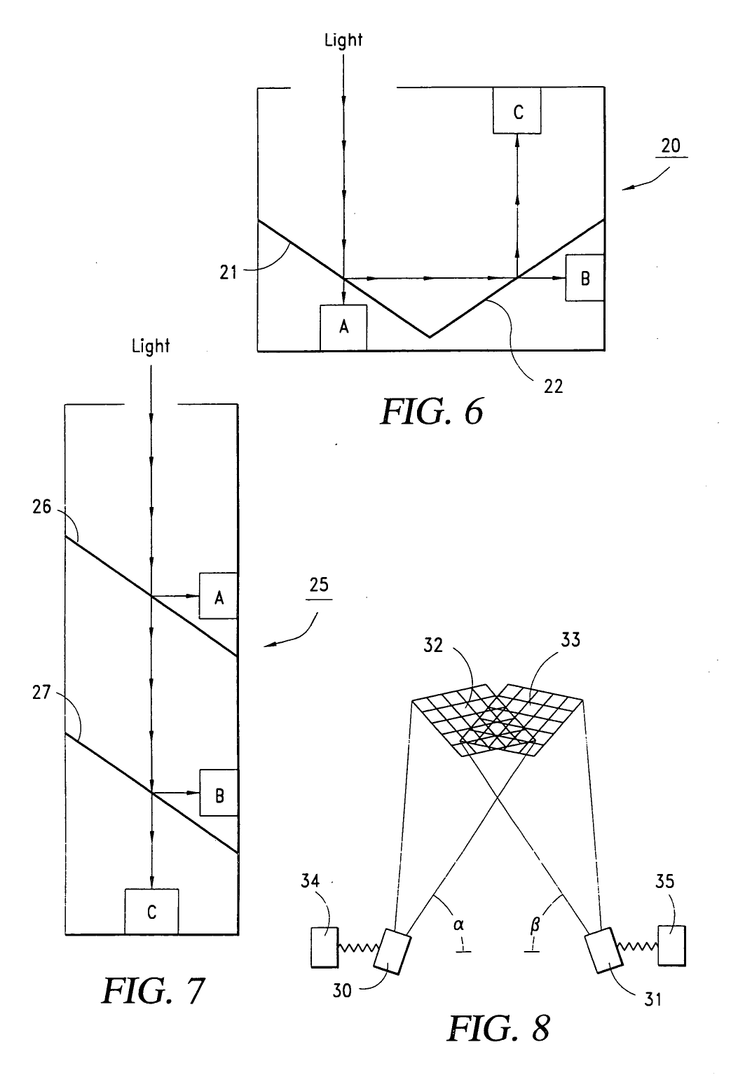

It will be appreciated by those skilled in the art that suitable beam splitters are well-known and readily available or manufacturable. In addition, the beam splitters may be replaced by other filter arrangements, such as an arrangement in which the composite image is filtered by parallel filters for the three frequencies, rather than series arrangements illustrated in FIGS. 6 and 7, i.e., the composite image duplicated twice and directed to separate filters for transmission of the respective images.

Finally, in the embodiment illustrated in FIG. 8, two projectors 30 and 31 are aimed at a subject (not shown), with the objective of creating a set of stereoscopic profiles corresponding to those illustrated in FIG. 5. However, the arrangement of this embodiment has the added feature that the azimuth of the projectors may be adjusted by mechanisms 34 and 35 so that the grids can be positioned on subjects at various distances from the projector. In that case, the azimuth angles α and β of the detectors when the grids overlap, i.e., upon alignment of corresponding hash marks, will give the relative angles and distance from the projectors to the subject.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

1. A system for capturing contours of a three-dimensional subject for display or processing by an electronic device, comprising:
a projector arranged to project a grid consisting of mutually perpendicular lines onto the subject; and
an image separation device arranged to separate an image of said projected grid from a superposed image of said subject,
wherein said a frequency of light forming said grid is different from a frequency of light captured in said superposed image of said subject, and
wherein said image separation device includes:
a filter device arranged to optically separate said image of said projected grid from said superposed image of said subject based on said different frequencies; and
at least two image detectors, one of which is positioned to receive said optically separated image of said projected grid and the other of which is positioned to receive said image of said subject.

2. A system as claimed in claim 1, wherein said grid is an infrared grid.

3. A system as claimed in claim 2, wherein said image of said subject is a visible light image of said subject.

4. A system as claimed in claim 1, wherein said image of said subject is a visible light image of said subject.

5. A system as claimed in claim 1, further comprising a second projector, said second projector being arranged to project light onto said subject from a different angle than said first projector, and said second projector being arranged to transmit light having a different frequency than said light transmitted by said first projector.

6. A system as claimed in claim 5, wherein said first and second grids are infrared grids of different frequency.

7. A system as claimed in claim 5, wherein said image of said subject is a visible light image of said subject.

8. A system as claimed in claim 5, wherein said filter device includes a pair of beam splitters, one of which is arranged to separate said visible light image from an image of said two infrared grids, and a second of which is arranged to separate a combined image of said two infrared grids into separate images of said two infrared grids.

9. A system as claimed in claim 1, wherein said filter device is a beam splitter.

10. A system as claimed in claim 1, wherein said grid is a two-dimensional grid projected onto a three-dimensional subject in order to determine contours of the subject based on distortion of the grid.

11. A system as claimed in claim 1, comprising a second said projector, at least one of said projectors having an adjustable orientation such that alignment of grids projected by said projectors on said subject enables a distance to said subject to be determined.

12. A system for capturing contours of a three-dimensional subject for processing by an electronic image processor, comprising:
a projector arranged to project an infrared grid consisting of static mutually perpendicular lines onto the subject; and
a lamp arranged to illuminate said subject in a generally uniform manner to form an image of said subject,
wherein a frequency of light forming said grid is different from a frequency of light used to illuminate said superposed image of said subject in a generally uniform manner.

13. A system as claimed in claim 12, wherein said image of said subject is a visible light image of said subject.

14. A system as claimed in claim 12, further comprising a second projector, said second projector being arranged to project light onto said subject from a different angle than said first projector, and said second projector being arranged to transmit light having a different frequency than said light transmitted by said first projector.

15. A system as claimed in claim 14, further comprising means for adjusting said different angle such that when grids projected by said projectors onto said subject coincide, a distance to said subject is determined.

16. A system as claimed in claim 15, wherein said first and second grids are infrared grids of different frequency.

17. A system as claimed in claim 16, wherein said image of said subject is a visible light image of said subject.

18. A system for capturing contours of a three-dimensional subject for processing by an electronic image processor, comprising
a filter device arranged to optically separate an image of a grid that has been projected onto the subject from a superposed image of said subject, one of said images being an infrared image and the other a visible light image, said filter device including two image detectors, one of which is positioned to receive said optically separated image of said projected grid the other of which is positioned to receive image of said subject.

19. A system as claimed in claim 18, wherein said filter device includes a pair of beam splitters, one of which is arranged to separate said visible light image from an image of said two infrared grids, and a second of which is arranged to separate a combined image of said two infrared grids into separate images of said two infrared grids.

20. A method of capturing contours of a three-dimensional subject for processing by an electronic image processor, comprising:
projecting a grid consisting of mutually perpendicular lines onto the subject; and
optically separating an image of said projected grid from a superposed image of said subject,
wherein a frequency of light forming said grid is different from a frequency of light captured in said superposed image of said subject.

21. A method as claimed in claim 20, wherein said grid is an infrared grid.

22. A method as claimed in claim 21, wherein said image of said subject is a visible light image of said subject.

23. A method as claimed in claim 20, wherein said image of said subject is a visible light image of said subject.

24. A method as claimed in claim 20, further comprising the step of projecting a second grid onto said subject, said second grid having a different frequency than said light transmitted by said first projector.

25. A method as claimed in claim 24, wherein said first and second grids are infrared grids of different frequency.

26. A method as claimed in claim 24, wherein said image of said subject is a visible light image of said subject.

27. A method as claimed in claim 18, further comprising the steps of projecting a second grid onto the subject, causing said second grid to coincide with said first grid, and determining a distance to the subject based on an angle of adjustment required to cause said first and second grids to coincide.

28. A system for targeting or finding the distance to a subject, comprising:
a pair of projectors arranged to project a pattern onto the subject; and
an image separation device arranged to separate respective images of said projected patterns from a superposed image of said patterns and said subject,
wherein frequencies of light forming respective said patterns is different from a frequency of light captured in said superposed image of said subject,
wherein said frequencies of light forming said respective said patterns are different from each other, and
wherein said image separation device includes:
a filter device arranged to optically separate said images of said projected patterns from said superposed image of said patterns and said subject based on said different frequencies; and
a filter device arranged to optically separate said images of said projected patterns from each other based on said different frequencies.
